(19) United States
(12) Patent Application Publication
(10) Pub. No.: US 2009/0135173 A1
(43) Pub. Date: May 28, 2009

(54) Liquid crystal display and method of driving liquid crystal display

(75) Inventor: Hitoshi Nakatsuka, Osaka (JP)

Correspondence Address: Yokoi & Company U.S.A., INC., 13700 Marina Pointe Drive, Suite #723, Marina Del Rey, CA, 90292, US

(73) Assignee: Funai Electric Co., Ltd., Osaka (JP)

(21) Appl. No.: 12/313,756

(22) Filed: Nov. 24, 2008

(30) Foreign Application Priority Data
Nov. 27, 2007 (JP) 2007-306474

(51) Int. Cl. G06F 3/038; G09G 3/28

(52) U.S. Cl. 345/212; 345/60

(57) ABSTRACT

In a liquid crystal display that generates a drive voltage based on input image data corresponding to an image, and applies the drive voltage to a liquid crystal pixel, thereby displaying the image, a plurality of sub-frame data for displaying a plurality of sub-frames are generated. On this occasion, a sub-frame data generation section varies a gray-scale value of the sub-frame data so that luminance values of the sub-frame data are different from each other. Thus, the view angle characteristic can be improved, and the display quality can also be improved.

### CROSS REFERENCE TO RELATED APPLICATIONS

The present application is related to the Japan Patent Application No. 2007-306474, filed Nov. 27, 2007, the entire disclosure of which is expressly incorporated by reference herein.

### BACKGROUND OF THE INVENTION

1. Field of the Invention

The present invention relates to driving of a liquid crystal display.

2. Description of the Related Art

As a drive method for a liquid crystal display, the hold type is widely known to the public. In the hold-type drive method, a voltage is applied only once in every frame period, and this state is maintained until the next frame. In the case in which the hold-type drive method and a liquid crystal panel (e.g., Twisted Nematic (TN) liquid crystal panel) with insufficient view angle are used in combination, the insufficient view angle characteristic of the liquid crystal display becomes prominent. In the hold-type liquid crystal display, the molecular arrangement of the liquid crystal material is held throughout one scan period, and therefore, the tilt angle of the light path of the light transmitted between the molecules is fixed accordingly to a constant angle. Therefore, the view angle recognized by the viewer side is also fixed.

Further, in the case with the hold-type liquid crystal display, the response characteristic of a signal applied to each of the liquid crystal pixels based on image data has a low-pass characteristic with lower amplitude in high-frequency band. In this case, since the spatial frequency characteristic of the image displayed is also lowered, moving images blur.

In JP-A-2004-69788 (Patent Document 1), in order for preventing deterioration of the color reproduction characteristic of the liquid crystal display caused by a temperature variation, image data for first and second sub-frames are produced based on image data for one frame. Further, the voltage value, which does not drive the liquid crystal panel, is set as the first pulse signal for the first sub-frame.

In JP-A-2001-75530 (Patent Document 2), although the technology is not available to liquid crystal displays, in a plasma display, one frame is divided into a plurality of sub-frames, thereby displaying the gray-scale without deterioration.

In JP-A-2006-292972 (Patent Document 3), contours caused when one frame is divided into sub-frames are reduced.

In JP-A-2006-243422 (Patent Document 4), one frame is divided into sub-frames, and a monochromatic color (white or black) image is displayed in either of the sub-frame periods, thereby improving the image quality.

In JP-A-2005-156723 (Patent Document 5), one frame is divided into sub-frames, thereby achieving prevention of turbulence of images and a stable operation of a deflection element.

The inventions disclosed in the Patent Documents 1 through 5 fail to improve the view angle characteristic in liquid crystal displays.

### BRIEF SUMMARY OF THE INVENTION

According to the present invention, there are provided a liquid crystal display capable of improving display quality while improving a view angle characteristic, and a method of driving the liquid crystal display.

A liquid crystal display for generating a drive voltage based on input image data, and apply the drive voltage to each pixel of a liquid crystal panel, thereby displaying an image, comprising:

a sub-frame data generation section for generating a plurality of sub-frame data based on each frame datum; and

a drive voltage generation section for executing digital-to-analog conversion on the sub-frame data generated by the sub-frame data generation section, generating the drive voltage based on a signal obtained by the digital-to-analog conversion, and displaying the sub-frame data sequentially in a period for displaying a frame data,

wherein the sub-frame data generation section varies a gray-scale value of each of the sub-frame data so that luminance values of the respective sub-frame data are different from each other.

In the present invention, the voltage value of the drive voltage varies between the sub-frames displayed in one frame period. Therefore, the molecular arrangement of the liquid crystal pixel to which the drive voltage is applied varies in one frame period, thus the tilt angle of the light path of the light transmitted through the liquid crystal pixel varies a predetermined angle. Therefore, the view angle characteristic can be improved, and the display quality can also be improved.

Here, the input image data includes not only the gray-scale data for displaying the image, but also various sync signals corresponding to the image.

In a specific embodiment of the invention, the sub-frame data generation section generates the sub-frame data so that display periods of the respective sub-frame data are different from each other.

In the invention configured as described above, since the display periods of the sub-frame data are generated so as to be different from each other, an equivalent effect to the case of disposing a plurality of sub-pixels in each pixel can be exerted. When the display period of the sub-frame increases while maintaining the number of levels of the gray-scale value constant, the number of levels of the gray-scale value of the image to be displayed in one frame is artificially increased. As a result, a desired gray-scale can be represented while keeping the small number of levels of the gray-scale value. As a result, the circuit configuration can be simplified, thus the manufacturing cost of the device can be reduced.

Here, the number of levels of the gray-scale value means the number of levels of the gray-scale levels which can be represented in each pixel. Further, the small number of levels of the gray-scale value means the number of levels of the gray-scale value no greater than 256 gray-scale levels, and more specifically, about 2 through 4 gray-scale levels.

In a specific embodiment of the invention, the sub-frame data generation section generates the sub-frame data so that a ratio of the display periods of the respective sub-frame data increases by a factor of 2.

In a specific embodiment of the invention, the sub-frame data generation section generates the sub-frame data by combining the display periods and the gray-scale value of the sub-frame data so as to prevent response time of the liquid crystal pixel from becoming insufficient.

In the invention configured as described above, the combinations of the display periods and the gray-scale value causing insufficient response time are eliminated. Therefore, the response time of the liquid crystal pixel can be improved.

In a specific embodiment of the invention, the sub-frame data generation section generates the sub-frame data so that the drive voltage has a pulse like waveform with a small signal width.

In the invention configured as described above, the pulsed drive voltage with a small signal width is applied to the liquid crystal pixel to drive the liquid crystal pixel. Therefore, the image can be prevented from blurring.

In a specific embodiment of the invention, the sub-frame data generation section generates the sub-frame data by

making display periods of the sub-frame data different from each other so that a ratio of the display periods of the respective sub-frame data increases by a factor of 2,

varying gray-scale data representing a gray-scale value of the sub-frame data so that the drive voltage has a pulse like waveform with a small signal width, and

combining the display periods and the gray-scale value of the sub-frame data so as to prevent response time of the liquid crystal pixel from becoming insufficient.

The present invention can be applied to a driving method for a liquid crystal display. Specifically, the present invention is a method of driving a liquid crystal display that generates a drive voltage based on input image data, and applies the drive voltage to each pixel of a liquid crystal panel, thereby displaying an image, comprising: generating a plurality of sub-frame data based on each frame data, and in generating the plurality of sub-frame data, making luminance values of the respective sub-frame data different from each other; executing digital-to-analog conversion on the sub-frame data generated to generate the drive voltage based on a signal obtained by the digital-to-analog conversion; and displaying the sub-frame data sequentially in a period for displaying a frame data.

### BRIEF DESCRIPTION OF THE DRAWINGS

FIG. 1 is a block configuration diagram of a liquid crystal display as an example.

FIG. 2 is a diagram for explaining a gray-scale value conversion table as an example.

FIG. 3 is a diagram for explaining a drive timing conversion table as an example.

FIG. 4 is a diagram for explaining a display period of each of sub-frames in a liquid crystal panel.

FIG. 5 is a diagram for explaining a relationship between voltage values and display periods for displaying respective levels of gray-scale values.

FIG. 6 is a diagram for explaining a relationship between voltage values and display periods for displaying respective levels of gray-scale values.

FIG. 7 is a diagram for explaining a relationship between voltage values and display periods for displaying respective levels of gray-scale values.

FIG. 8 is a diagram for explaining a relationship between voltage values and display periods for displaying respective levels of gray-scale values.

FIG. 9 is a diagram showing a response table representing a response characteristic of liquid crystal pixels.

### DETAILED DESCRIPTION OF THE INVENTION

Hereinafter, an embodiment of the present invention will be explained along the following order. It should be noted that the same or equivalent parts will be denoted with the same reference numerals, and duplication of the explanations therefor will be eliminated.

### 1. First Embodiment

### 1.1. Configuration of Liquid Crystal Display

### 1.2. Method of Driving Liquid Crystal Display

### 1.3. Relationship Between Display Period and Voltage Value in Sub-frame

### 1. First Embodiment

### 1.1. Configuration of Liquid Crystal Display

The liquid crystal display according to the present invention obtains input image data and drives liquid crystal pixels forming a screen based on the input image data. The liquid crystal display 100 produces a plurality of sub-frame data from frame data for one frame in the input image data. The sub-frames produced based on the sub-frame data are all displayed in a period of one frame. According to this process, the pseudo gray-scale corresponding to the number of gray-scale levels of the frame can be represented. Further, since the luminance values of the respective sub-frame data are different between the sub-frames, the arrangement of the liquid crystal molecules varies in one frame period, thus the view angle characteristic in the screen is improved.

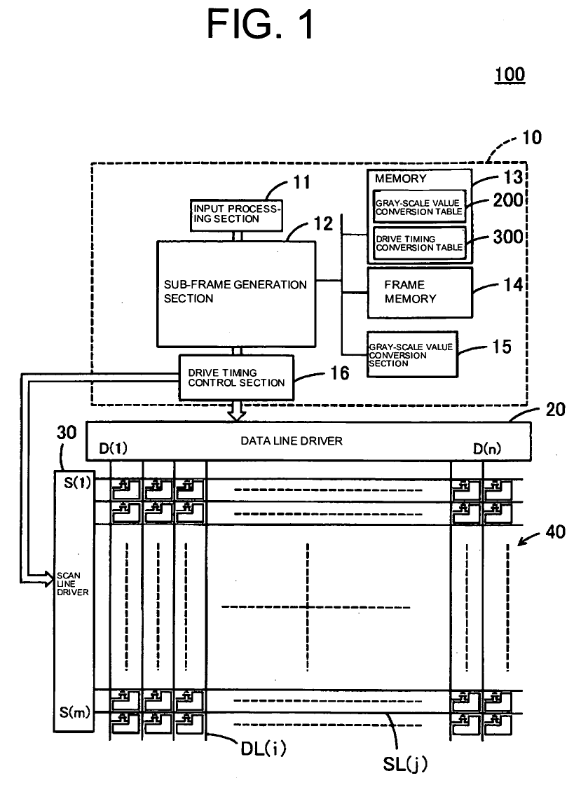

FIG. 1 is a block configuration diagram of the liquid crystal display. The liquid crystal display 100 is provided with a drive image data generation section 10 (a sub-frame data generation section), a data line driver 20, a scan line driver 30, and a liquid crystal panel 40. The drive image data generation section 10 acquires image data from an external device (not shown), generates image signals consisting of the sub-frame data based on the image data, and outputs the image signals to the data line driver 20 and the scan line driver 30. The data line driver 20 and the scan line driver 30 scan the liquid crystal pixels of the liquid crystal panel 40 with a predetermined period to make the liquid crystal panel 40 display an image.

The drive image data generation section 10 is provided with an input processing section 11, a sub-frame generation section 12, a memory 13, a frame memory 14, a gray-scale value conversion section 15, and a drive timing control section 16. The drive image data generation section 10 generates a plurality of sub-frame data from the frame data, the sub-frame data respectively having display periods and gray-scale values (luminance values) different from each other. Here, the frame data denotes the data for generating a frame displayed in one frame in the input image data.

The input processing section 11 is an interface for obtaining the digital input image data from an external device. The input processing section 11 obtains the digital input image data from the external device (not shown), and outputs the input image data to the sub-frame generation section 12. Here, the input image data includes not only the gray-scale data for displaying the image, but also various sync signals corresponding to the image, such as a vertical sync signal Vsyn and a horizontal sync signal Hsyn. The external devices include not only a discrete device such as a recording reproducing device or a PC, but also a region in the present liquid crystal display 100 not directly related to driving of the liquid crystal panel. For example, an image processing circuit executing image processing on the input image data in the posterior stage of the drive image data generation section 10 corresponds to the external device.

The sub-frame generation section 12 extracts the frame data from the input image data input via the input processing section 11, and generates the plurality of sub-frame data based on the frame data. The sub-frame generation section 12 stores the sub-frame data, which is thus generated, in the frame memory 14. The frame data denotes the data of a still image as a unit composing a moving image, and is defined in each of the vertical sync periods. In the case in which the frequency of the vertical sync signal Vsyn is 60 Hz, the frame data represent images each displayed on the screen at a frame frequency of 60 Hz, namely in every frame period of 16.7 ms. The number of sub-frames can be set to any number. Hereinafter, it is assumed that in the present embodiment, the sub-frame generation section 12 generates three sub-frame data from each frame data.

The memory 13 is composed of a semiconductor memory device such as a Read-Only Memory (ROM). The memory 13 stores various tables for converting the gray-scale value (the luminance value) of the sub-frame data thus generated and the display period. Specifically, the memory 13 stores a gray-scale value conversion table 200 for converting the gray-scale value of the sub-frame data and a drive timing conversion table 300 for converting the display period of the sub-frame data.

The frame memory 14 is composed of a semiconductor memory device such as a Random Access Memory (RAM). The frame memory 14 temporarily stores the sub-frame data thus generated. The frame memory 14 functions as a buffer for each of the sections of the drive image data generation section 10 to store the sub-frame data thus generated therein and to retrieve the sub-frame data thus generated therefrom.

The gray-scale value conversion section 15 converts the gray-scale value of each of the sub-frame data so that a display sum of the sub-frame data in one frame and the gray-scale value of the original frame data become equal to each other. Here, the display sum means the gray-scale value or the luminance value observed when the sub-frames are displayed in one frame period. The gray-scale value conversion section 15 looks up the gray-scale value conversion table 200, and converts the gray-scale value of each of the sub-frame data stored in the frame memory 14. The gray-scale values obtained from the gray-scale value conversion table 200 are gray-scale values for artificially representing the gray-scale value (the luminance value) of the original frame using the display sum of the sub-frame data.

It should be noted that the gray-scale value of the frame represented artificially by the plurality of sub-frames is not determined only by the gray-scale value of each of the sub-frames, but is related to the display period of each of the sub-frames described below. Specifically, the display sum is basically an average gray-scale value in the entire one frame period. Therefore, if the period of each of the sub-frames is the same, the display sum becomes equal to the average value of the gray-scale values of the respective sub-frames. However, if the periods of the respective sub-frames are different from each other, the display sum becomes the average value of the values obtained by multiplying the gray-scale values of the respective sub-frames by the weights inversely proportional to the periods of the corresponding sub-frames.

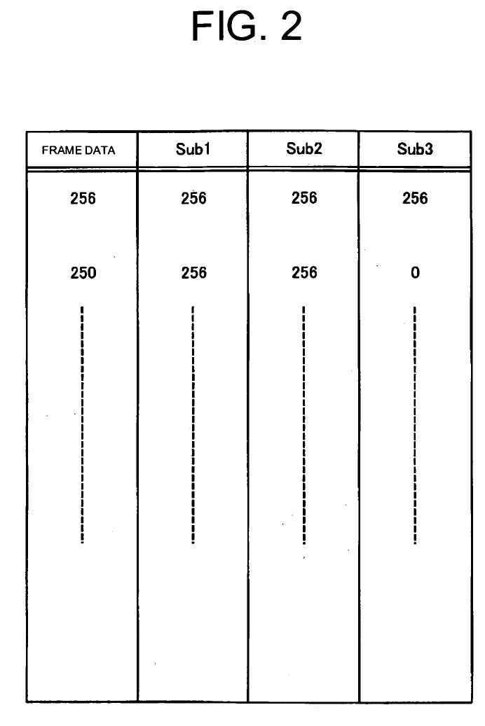

FIG. 2 is a diagram for explaining the gray-scale value conversion table. The sub-frame generation section 12 generates three sub-frame data having the same gray-scale values based on one frame datum. Therefore, in this stage, the gray-scale value of each of the sub-frame data to be generated and the gray-scale value of the original frame data are the same.

The gray-scale value conversion table 200 stores gray-scale values of the three sub-frame data (Sub1 through Sub3) corresponding to the gray-scale value of the original frame data. The gray-scale values stored in the gray-scale value conversion table 200 are different between the sub-frame data, as described above.

The gray-scale value conversion section 15 looks up the gray-scale conversion table 200 to convert the gray-scale values of the sub-frame data.

The drive timing control section 16 converts the display period of each of the sub-frame data. The drive timing control section 16 looks up the drive timing conversion table 300 to obtain the display period of each of the sub-frame data stored in the frame memory 14. Specifically, the drive timing control section 16 converts the vertical sync signal Vsyn and the horizontal sync signal Hsyn of the frame data into the vertical sync signal Vsynsub and the horizontal sync signal Hsynsub representing the sync signals of each of the sub-frame data, respectively. It should be noted that the order of the vertical sync signal Vsynsub and the horizontal sync signal Hsynsub of each of the sub-frame data thus converted matches the order of the sub-frame data (Sub1 through Sub3) to be displayed on the screen.

The vertical sync signal Vsynsub and the horizontal sync signal Hsynsub generated by the drive timing control section 16 are provided with a latch pulse (hereinafter described as LP), a data line driver start pulse (hereinafter described as DSP), a scan line driver start signal (hereinafter described as SSP), and a scan line driver clock signal (hereinafter described as SCK).

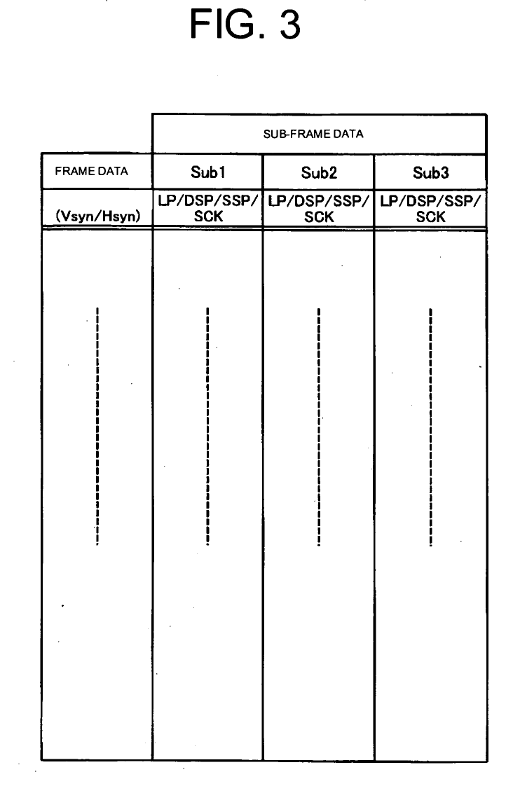

FIG. 3 is a diagram for explaining the drive timing conversion table. The drive timing conversion table 300 stores the vertical sync signal Vsynsub and the horizontal sync signal Hsynsub of each of the sub-frame data in correspondence with the vertical sync signal Vsyn and the horizontal sync signal Hsyn of the original frame data. More specifically, as shown in FIG. 3, the drive timing conversion table 300 stores the LP, DSP, SSP, and SCK described above.

The data line driver 20 executes digital-to-analog conversion on the sub-frame data generated by the drive image data generation section 10 to generate a sub-frame voltage Vsub. The data line driver 20 is provided with a sampling memory, a holding memory, and an output circuit section. Each of the sub-frame data output by the drive timing control section 16 is stored in the sampling memory in sync with input timing of the latch pulse LP. After the sampling memory stores all of the sub-frame data, the sub-frame data stored in the sampling memory are then stored to the holding memory in response to output of the DSP. Then, the sub-frame data are transmitted to the output circuit section, and the output circuit section executes the digital-to-analog conversion on the sub-frame data based on a gray-scale voltage, and outputs the result as the sub-frame voltage Vsub. It should be noted that the sub-frame voltage Vsub has a voltage value generated in accordance with the gray-scale value of the sub-frame data. Therefore, by applying the sub-frame voltage Vsub, the sub-frames with different luminance values from each other are displayed. Further, the output circuit section supplies the sub-frame voltage Vsub from output terminals D(i) of the data line driver 20 to source electrodes of thin film transistors Q (described later) via the data lines DL(i), respectively.

The scan line driver 30 generates gate signals for selecting the pixel columns to which the analog image data is applied based on the sync signals generated by the drive image data generation section 10. The gate signals are used for scanning the liquid crystal panel 40 in sync with the horizontal sync signal Hsynsub of each of the sub-frames. Therefore, the display period of the sub-frame is obtained by multiplying the gate signals by the number of the scan lines of the sub-frame data.

The scan line driver 30 is provided with n stages of shift registers, and a level converter for outputting the gate signals. When the signals SSP and SCK supplied from the drive timing control section 16 are input to the shift register, the shift register acquires the signal SSP with the timing of the rising edge of the signal SCK, and shifts the leading bit with the timing of the falling edge of the signal SCK. Each bit of the shift register outputs the gate signal sequentially to the scan lines SL(j) via the level converter. The data line driver 20 and the scan line driver 30 realize a drive data generation section.

The liquid crystal panel 40 displays image when the analog image data is applied to each of the pixels. The liquid crystal panel 40 is provided with a pair of glass substrates (an upper glass substrate, a lower glass substrate), a liquid crystal layer held between the glass substrates, and polarization plates for polarizing light. On the upper glass substrate, there are attached a color filter for separating the transmitted light into respective colors of R (red), G (green), and B (blue), and an opposed electrode to which a common voltage Vcom as a reference voltage of the drive voltage is applied. Further, on the lower glass substrate, there are attached the thin film transistors (TFT) Q as switching elements, display electrodes E(i,j) connected to drain electrodes of the thin film transistors Q to apply the sub-frame voltage Vsub thereto, the data lines DL(i) for connecting the output terminals S(i) of the data line driver 20 with source electrodes of the thin film transistors Q, respectively, and the scan lines SL(j) for connecting the output terminals S(j) of the scan line driver 30 with gate electrodes of the thin film transistors Q, respectively.

### 1.2. Method of Driving Liquid Crystal Display

A method of driving the liquid crystal display having the configuration described above will hereinafter be explained.

When the input image data is input from the external device, the drive image data generation section 10 generates the sub-frame data, and the sync signals corresponding to the sub-frame data, namely, the signals LP, DSP, SSP, and SCK. Further, the scan line driver 30 generates the gate signals synchronized with the horizontal sync signal Hsynsub based on the signals SSP and SCK. Then, the data line driver 20 generates the sub-frame voltage Vsub using the sub-frame data and the signals LP and DSP, and applies the sub-frame voltage Vsub sequentially to specific pixel columns in sync with output of the gate signals. Therefore, the liquid crystal panel 40 sequentially displays the sub-frames in sync with the vertical sync signal Vsynsub.

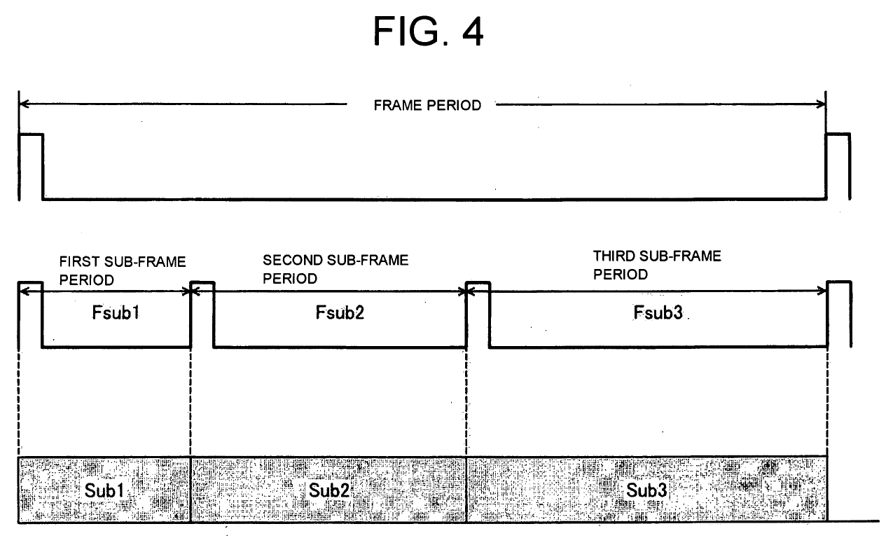

FIG. 4 is a diagram for explaining the display period of each of the sub-frames in the liquid crystal panel. As shown in FIG. 4, in the present embodiment, the liquid crystal display divides the one frame period into three sub-frame periods (Fsub1, Fsub2, and Fsub3), and displays the sub-frames, which have the display periods and the luminance values different from each other, in the respective sub-frame periods. In this case, the respective display periods of the first through third sub-frames gradually increase in this order. In the present embodiment, the display periods of the respective sub-frames (Sub1 through Sub3) gradually increase so that the ratio therebetween is a multiple of two. Further, the luminance value of each of the sub-frames is stored in the gray-scale value conversion table 200, and the display sum in one frame is arranged to be equal to the luminance value of the original frame.

As is explained hereinabove, since the gray-scale values (the luminance values) of the respective sub-frames are different from each other, the molecular arrangement of the liquid crystal material varies in one frame period. Therefore, the light path of the light emitted from the backlight or the like is changed a predetermined angle in every sub-frame, thus varying the angle at which the light to be viewed is transmitted. Therefore, the view angle characteristic in the liquid crystal panel 40 is improved. It should be noted that in the case in which the liquid crystal panel 40 is configured as the Twisted Nematic (TN) liquid crystal panel or the Vertically Aligned (VA) liquid crystal panel having insufficient view angle characteristics, the improvement in the view angle characteristic becomes more prominent.

### 1.3. Relationship Between Display Period and Voltage Value in Sub-Frame

In the present invention, the gray-scale value conversion table 200 and the drive timing conversion table 300 store the gray-scale value in each of the sub-frames, and the vertical sync signal Vsynsub and the horizontal sync signal Hsynsub representing the drive timing, respectively.

In the present invention, by setting the values stored in the respective tables to be the values explained hereinafter, the number of levels of the gray-scale value (the luminance value) larger than the number of levels of the voltage value can be realized. Here, the number of levels of the gray-scale value means the number of levels of the gray-scale value (the luminance value) in the display sum of each of the sub-frame.

It should be noted that in the case in which the number of levels of the voltage value is two, namely a black level and a white level, since the waveform of the sub-frame voltage Vsub becomes like a pulse signal with small width (so-called an impulse waveform), a blurred image is improved.

When the display period increases, the same effect is exerted as in the case in which the aperture ratio of the sub-pixel in each of the pixels increases. In the present embodiment, firstly, the display period of each of the sub-frames stored in the drive timing conversion table 300 is increased. Further, the sub-frame voltage Vsub corresponding to the gray-scale value stored in the gray-scale value conversion table 200 is made to correspond to a combination of the levels of voltage value, which is smaller than the number of levels of the gray-scale value. In this manner, the luminance value of the original frame can be represented by the display sum of the sub-frames. Therefore, according to the present invention, representation of the original gray-scale value can be realized by the smaller number of levels of the sub-frame voltage Vsub. Therefore, according to the present invention, the circuit configuration can be simplified.

For example, in the case in which the gray-scale value is transmitted using a parallel transmission channel, it becomes possible to reduce the number of transmission wires. As a result, the cost of the device can be reduced.

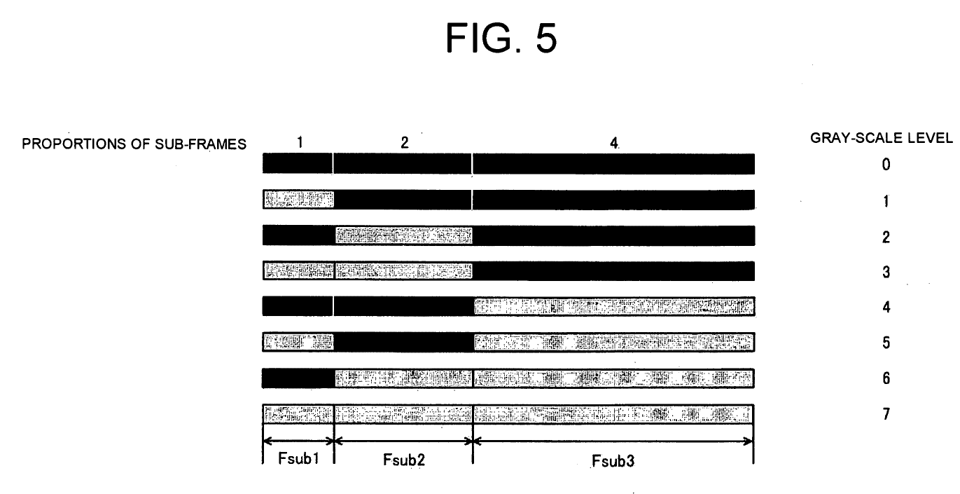

FIGS. 5 through 7 are diagrams for explaining a relationship between the voltage values and the display periods for displaying respective levels of gray-scale values.

In the present embodiment, the number of the sub-frames is three, and the sub-frame periods increase in order. In the case in which the ratio of the display periods of the sub-frames increases twice in order, the relationship between the voltage values of the respective sub-frames and the levels of the gray-scale value becomes as shown in FIG. 5.

The relationship shown in the drawing can be expressed by the following condensed formula. The number Gra of the levels of the gray-scale value is expressed by the formula described below assuming that the number of the sub-frame is n, and the number of levels of the voltage value is m.

Gra=1+Σ2̂(i−1)×(m−1) (i=1 through n) (1)

According to the formula (1), in the case in which the number (n) of the sub-frames is 3, and the number (m) of levels of the voltage value is 2, the number Gra of levels of the gray-scale value is obtained by the following formula.

Gra=1+(2̂+2̂1+2̂2)×(2−1)=8

Therefore, in the case in which the display periods of the 3 sub-frames are different from each other, assuming that the 2 levels of voltage value are used, 8 levels of gray-scale value can be represented in one frame.

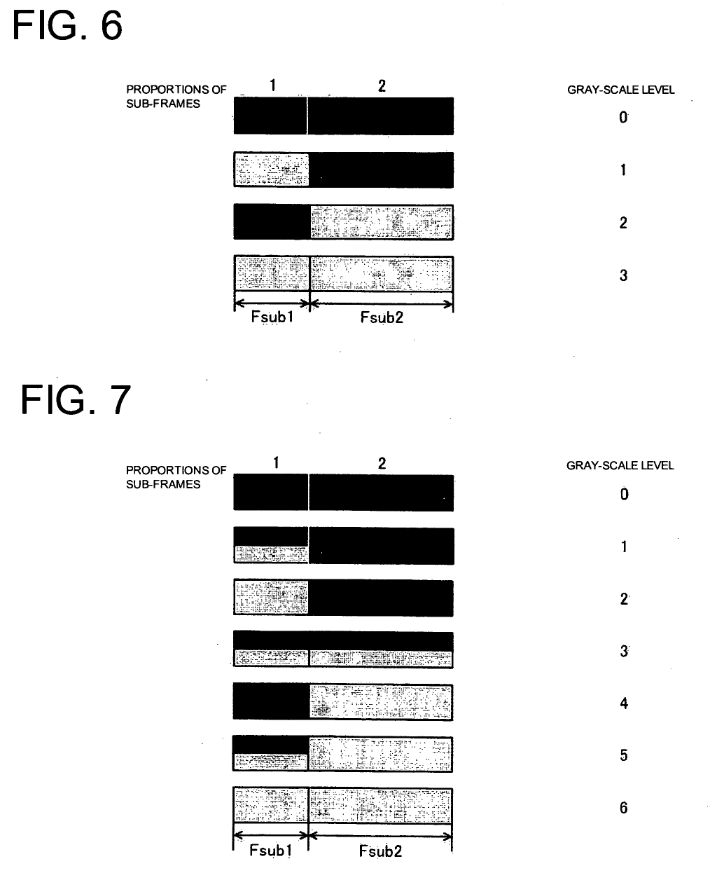

In a similar manner, as shown in FIG. 6, in the case in which the number (n) of sub-frames is 2, and the number (m) of levels of the voltage value is 2, the number Gra of levels of the gray-scale value is calculated as follows based on the formula (1).

Gra=1+(2̂0+2̂1)×(2−1)=4

Therefore, in the case in which the display periods of the 2 sub-frames are different from each other, assuming that the 2 levels of voltage value are used, 4 levels of gray-scale value can be represented in one frame.

As shown in FIG. 7, in the case in which the number (m) of levels of the voltage value is 3, the number Gra of levels of the gray-scale value is calculated as follows based on the formula (1).

Gra=1+(2̂0+2̂1)×(3−1)=7

Therefore, in the case in which the display periods of the 3 sub-frames are different from each other, assuming that the 3 levels of voltage value are used, 7 levels of gray-scale value can be represented.

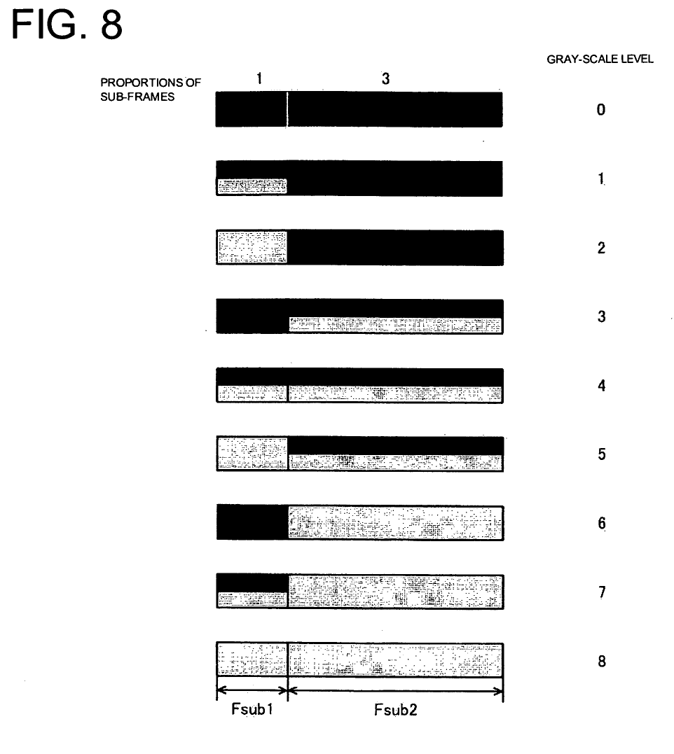

Further, in the case in which the ratio of the display periods of the sub-frames is not increased twice in order as shown in FIG. 8, the number Gra of levels of the gray-scale value is approximately represented using the following formula (2).

Gra=(n+1)×(m+1) (2)

In the case in which the number (n) of the sub-frames is 2, and the number (m) of levels of the voltage value is 3, the number Gra of levels of the gray-scale value is obtained as follows.

Gra=(2+1)×3=9

Therefore, 9 levels of gray-scale value can be represented using 3 levels of the voltage value.

Further, some of the levels of gray-scale value can be represented with the combinations of the display periods in the sub-frames and a smaller number of levels of the voltage value (the gray-scale value). Incidentally, in such combinations, there is a combination with which the response characteristic of the liquid crystal panel is not preferable. However, it is possible to replace such a combination with which the response characteristic of the liquid crystal panel is not preferable with another combination of the display period with a preferable response characteristic and the voltage value. In this manner, the response characteristic of the liquid crystal panel can be improved.

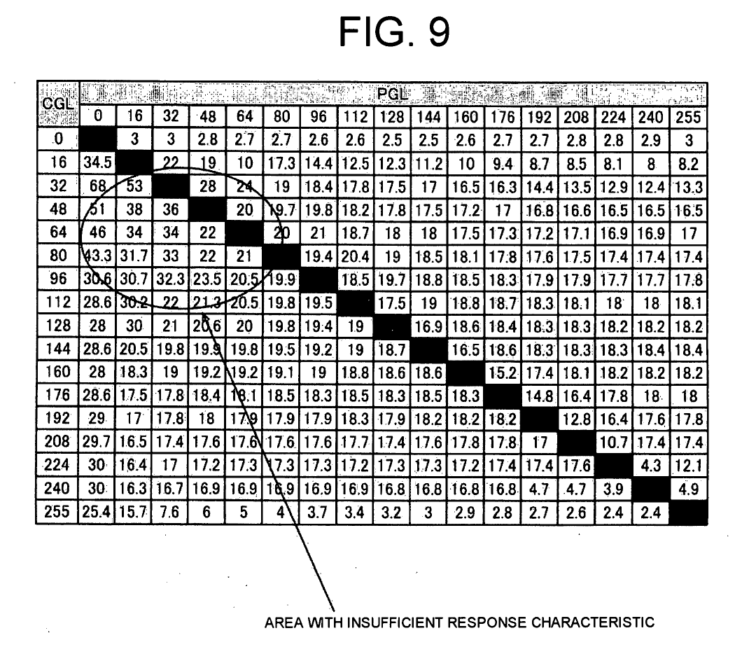

FIG. 9 is a diagram showing a response table representing the response characteristic of the liquid crystal pixels. The area on the table surrounded with a solid line is an area with insufficient response characteristic. Even in the case with the transition of the gray-scale value with an insufficient response characteristic, by changing the combination of the display periods and the levels of the gray-scale value, the transition of the gray-scale value with the insufficient response characteristic can be replaced with another transition of the gray-scale value with a preferable response characteristic. Thus, according to the present invention, the response characteristic of the liquid crystal panel can be improved.

As is explained hereinabove, when generating a plurality of sub-frame data based on the frame data, the gray-scale value of each of the sub-frame data is set so that the luminance values of the respective sub-frame data are different from each other. Thus, the view angle characteristic can be improved, and the display quality can also be improved.

It should be noted that it is obvious that the present invention is not limited to the embodiment described above. It is obvious to those skilled in the art that the following matters are disclosed as an embodiment of the present invention.

To apply the members replaceable with each other or configurations and so on replaceable with each other disclosed in the embodiments described above with the combination thereof appropriately modified.

To appropriately replace the member, configuration, and so on not disclosed in the embodiments described above and included in the known technology and replaceable with the member, configuration, and so on disclosed in the embodiments described above, or to apply the member, configuration, and so on not disclosed in the embodiments described above and included in the known technology and replaceable with the member, configuration, and so on disclosed in the embodiments described above with the combination thereof modified.

To appropriately replace the member, configuration, and so on disclosed in the embodiments described above with the member, configuration, and so on not disclosed in the embodiments described above and assumed by those skilled in the art to be the replacements of the member, configuration, and so on disclosed in the embodiments described above, or to apply the member, configuration, and so on not disclosed in the embodiments described above and assumed by those skilled in the art to be the replacements of the member, configuration, and so on disclosed in the embodiments described above with the combination thereof modified.

While the invention has been particularly shown and described with respect to preferred embodiment thereof, it should be understood by those skilled in the art that the foregoing and other changes in form and detail may be made therein without departing from the spirit and scope of the invention as defined in the appended claims.

What is claimed is:

1. A liquid crystal display for generating a drive voltage based on input image data, and apply the drive voltage to each pixel of a liquid crystal panel, thereby displaying an image, comprising:
a sub-frame data generation section for generating a plurality of sub-frame data based on each frame datum; and
a drive voltage generation section for executing digital-to-analog conversion on the sub-frame data generated by the sub-frame data generation section, generating the drive voltage based on a signal obtained by the digital-to-analog conversion, and displaying the sub-frame data sequentially in a period for displaying a frame data,
wherein the sub-frame data generation section varies a gray-scale value of each of the sub-frame data so that luminance values of the respective sub-frame data are different from each other.

2. The liquid crystal display according to claim 1, wherein
the sub-frame data generation section generates the sub-frame data so that display periods of the respective sub-frame data are different from each other.

3. The liquid crystal display according to claim 2, wherein
the sub-frame data generation section generates the sub-frame data so that a ratio of the display periods of the respective sub-frame data increases by a factor of 2.

4. The liquid crystal display according to claim 2, wherein
the sub-frame data generation section generates the sub-frame data by combining the display periods and the gray-scale value of the sub-frame data so as to prevent response time of the liquid crystal pixel from becoming insufficient.

5. The liquid crystal display according to claim 1, wherein
the sub-frame data generation section generates the sub-frame data so that the drive voltage has a pulse like waveform with a small signal width.

6. The liquid crystal display according to claim 1, wherein
the sub-frame data generation section generates the sub-frame data by
generating display periods of the sub-frame data different from each other so that a ratio of the display periods of the respective sub-frame data increases by a factor of 2,
varying gray-scale data representing a gray-scale value of the sub-frame data so that the drive voltage has a pulse like waveform with a small signal width, and
combining the display periods and the gray-scale value of the sub-frame data so as to prevent response time of the liquid crystal pixel from becoming insufficient.

7. A method of driving a liquid crystal display that generates a drive voltage based on input image data, and applies the drive voltage to each pixel of a liquid crystal panel, thereby displaying an image, comprising:
generating a plurality of sub-frame data based on each frame data, and in generating the plurality of sub-frame data, making luminance values of the respective sub-frame data different from each other;
executing digital-to-analog conversion on the sub-frame data generated to generate the drive voltage based on a signal obtained by the digital-to-analog conversion; and
displaying the sub-frame data sequentially in a period for displaying a frame data.
